(19) United States
(12) Patent Application Publication
(10) Pub. No.: US 2024/0249362 A1
(43) Pub. Date: Jul. 25, 2024

(54) BUNDLED HEALTH CARE PAYMENT ADVISOR

(71) Applicant: OPTUM, INC., Minnetonka, MN (US)

(72) Inventors: Jimmy Nathaniel Liu, Cherry Hill, NJ (US); Jianjun Cai, Alpharetta, GA (US)

(21) Appl. No.: 18/101,249

(22) Filed: Jan. 25, 2023

(51) Int. Cl. G06Q 40/08

(52) U.S. Cl. CPC G06Q 40/08

(57) ABSTRACT

A system for managing bundled payment agreements in a health care setting is configured to obtain, from a health care provider, an electronic health care claim; compare attributes of the electronic health care claim to a repository of bundled payment agreements to determine whether: i) the electronic health care claim is associated with a bundled payment agreement between the health care provider and a payor, and ii) one or more bundling criteria are met; reject the electronic health care claim if it is determined that the electronic health care claim is associated with a bundled payment agreement and that the bundling criteria are not met; and generate a transaction log of the evaluation of the claim.

### BACKGROUND

Bundled payment programs are a growing, alternative model for paying health care costs. Under a bundled payment model, health care providers receive, from a payor (e.g., an insurance company), a single payment for all the services performed for a patient care episode, as opposed to receiving individual payments for each service (e.g., office visits, lab work, etc.). Consider, for example, a knee surgery. Traditionally, each health care provider (e.g., a surgeon, an anesthesiologist, the hospital, etc.) would be individually reimbursed for their part of the patient care episode. In contrast, the health care providers would be collectively reimbursed for the patient care episode at a predetermined or “set” price under a bundled payment model. In some cases, a single entity (e.g., the hospital) is reimbursed, and subsequently distributes the payment to additional parties associated with a patient care event. In other cases, the payor may reimburse each entity associated the patient care event individually but may adjust each payment according to the predetermined price. Payments may also be retrospectively bundled, which involves paying all the claims on a fee-for-service basis and then reconciling later based on the episode and bundle agreement.

Administering and executing bundled payments today involves creating a highly customized solution that is often suited only for the specific payor and providers involved. Payment reconciliation is also a highly manual and customized process filled with disputes and discrepancies that requires a great deal of human oversight. In some cases, payors have developed custom solutions to manage and reconcile bundled payments, but these solutions are often very limited in their capabilities and generally only one party (e.g., the payor) can view and maintain rules that define the bundled payments. Additionally, providers are generally not able to manage or administer bundled payments despite their need to coordinate claims submissions (e.g., across multiple parties that may be involved in delivering care), and a convener is generally required to distribute payments to each party based on their contribution of care during the episode.

### SUMMARY

One implementation of the present disclosure is a system including a processor and a memory having instructions stored thereon that, when executed by the processor, cause the system to obtain, from a first computing device associated with a health care provider, an electronic health care claim, compare attributes of the electronic health care claim to a repository of bundled payment agreements to determine whether: i) the electronic health care claim is associated with a bundled payment agreement between the health care provider and a payor, and ii) one or more bundling criteria are met, reject the electronic health care claim if it is determined that the electronic health care claim is associated with a bundled payment agreement and that the one or more bundling criteria are not met, where rejecting the electronic health care claim includes to transmit a notification to the first computing device indicating a reasoning for rejecting the electronic health care claim and to prompt the health care provider to resubmit the electronic health care claim after modifying one or more portions of the electronic health care claim to meet the one or more bundling criteria, and generate a transaction log including details of the electronic health care claim, an indication of whether the electronic health care claim is associated with a bundled payment agreement, and an indication of whether or not the electronic health care claim was rejected.

Another implementation of the present disclosure is a method including obtaining, by a first computing device, from a second computing device associated with a health care provider, an electronic health care claim, comparing, by the first computing device, attributes of the electronic health care claim to a repository of bundled payment agreements to determine whether: i) the electronic health care claim is associated with a bundled payment agreement between the health care provider and a payor, and ii) one or more bundling criteria are met, rejecting, by the first computing device, the electronic health care claim if it is determined that the electronic health care claim is associated with a bundled payment agreement and that the one or more bundling criteria are not met, where rejecting the electronic health care claim includes transmitting a notification to the second computing device indicating a reasoning for rejecting the electronic health care claim and prompting the health care provider to resubmit the electronic health care claim after modifying one or more portions of the electronic health care claim to meet the one or more bundling criteria, a transaction log including details of the electronic health care claim, an indication of whether the electronic health care claim is associated with a bundled payment agreement, and an indication of whether or not the electronic health care claim was rejected.

Yet another implementation of the present disclosure is a non-transitory, computer readable medium having instructions stored thereon that, when executed by a processor, cause a device to obtain, from a first computing device associated with a health care provider, an electronic health care claim, compare attributes of the electronic health care claim to a repository of bundled payment agreements to determine whether: i) the electronic health care claim is associated with a bundled payment agreement between the health care provider and a payor, and ii) one or more bundling criteria are met, reject the electronic health care claim if it is determined that the electronic health care claim is associated with a bundled payment agreement and that the one or more bundling criteria are not met, where rejecting the electronic health care claim includes to transmit a notification to the first computing device indicating a reasoning for rejecting the electronic health care claim and prompt the health care provider to resubmit the electronic health care claim after modifying one or more portions of the electronic health care claim to meet the one or more bundling criteria, and generate a transaction log including details of the electronic health care claim, an indication of whether the electronic health care claim is associated with a bundled payment agreement, and an indication of whether or not the electronic health care claim was rejected.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIGS. 1A and 1B are block diagrams of various communication architectures for identifying and processing electronic health care claims that are part of bundled payment agreements, according to some implementations.

FIG. 2 is a block diagram of a communication architecture for checking whether an electronic health care claim is part of a bundled payment agreement before submission, according to some implementations.

FIG. 3 is a detailed block diagram of a bundled payment advisor, according to some implementations.

FIGS. 4A and 4B are a flow diagram of a process for automatically identifying electronic health care claims that are part of a bundled payment agreement, according to some implementations.

FIG. 5 is a flow diagram of a process for monitoring for, and detecting, a trigger event that initiates adjudication of a bundled payment, according to some implementations.

FIG. 6 is a flow diagram of a process for determining whether an electronic health care claim is part of a bundled payment agreement prior to submission, according to some implementations.

### DETAILED DESCRIPTION

Referring generally to the figures, a system and methods for managing bundled health care payments are shown, accordingly to various implementations. Generally, the system and methods are described herein with respect to a “Bundled Payment Advisor”, which is a tool for managing bundled health care payments. At a high level, Bundled Payment Advisor acts as a repository for storing bundled payment agreements, which can be accessed by multiple parties. Specifically, in some implementations, Bundled Payment Advisor is accessible by both health care providers and health care payors such that all parties can enter, view, and/or edit bundled payment agreements and/or bundled payment agreement parameters. Bundled payment agreements, as mentioned above, are agreements established between two or more parties—generally, health care providers and payors—that a single payment is to be made for a predefined episode of care. Accordingly, each bundled payment agreement is generally defined by multiple care events (e.g., office visits, surgeries, specialist fees, etc.) and has a fixed fee. For example, a bundled payment agreement for cardiac bypass surgery may set a fixed fee that covers pre and post-operative office visits, medications, and surgery related activities (e.g., costs for the surgery team, anesthesiologists, hospital fees, etc.).

In addition to managing the bundled payment agreements themselves, Bundled Payment Advisor may be further configured to automatically detect health care claims that are part of bundled payment agreements. In some such implementations, Bundled Payment Advisor may receive or intercept electronic health care claim submissions, extract relevant attributes of the electronic health care claim submissions, and use the extracted attributes to determine whether the electronic health care claim submissions are associated with predefined bundled payment agreements. In some implementations, Bundled Payment Advisor can further determine whether the electronic health care claims that are part of bundled payment agreements are in a proper format for further processing. For example, Bundled Payment Advisor may determine if a billed amount of each electronic health care claim that is part of a bundle is zero. If not, Bundled Payment Advisor may reject the improper electronic health care claim and transmit the claim and/or a corresponding notification to the sending device (e.g., a health care provider that submitted the claim). Non-issue or resolved claims may be forwarded to a recipient device (e.g., associated with a health care payor).

It will be appreciated that these and other features of Bundled Payment Advisor may address certain shortcomings of existing technologies. For example, Bundled Payment Advisor is not necessarily tied to a specific health care provider or payor, allowing multiple parties to access bundled payment arrangement details for viewing, editing, and the like, whereas, traditionally, only a single party (e.g., the payor) has visibility and control of bundled payment agreements. To this point, Bundled Payment Advisor is agnostic or “neutral” with regards to the parties involved—no one party has more control and both parties have the same view and transparency and ability to view and edit the bundling rules. Bundled Payment Advisor also provides a digital repository of bundled payment agreements for multiple providers and payors.

Further, Bundled Payment Advisor reduces the burden on payors by automatically detecting claims that are associated with bundled payments and prompting providers to correct improper claims. Unlike existing technologies, this detection and flagging/correcting of claims as part of bundled payment agreements occurs prior to receipt by a payor (e.g., is prospective). Thus, payors may only need to spot-check submitted claims rather than individually processing and reconciling all claims themselves. In some cases, Bundled Payment Advisor can track the history of submitted claims and bundles for later audits or reviews. Additional features of Bundled Payment Advisor are described in greater detail below.

### Overview

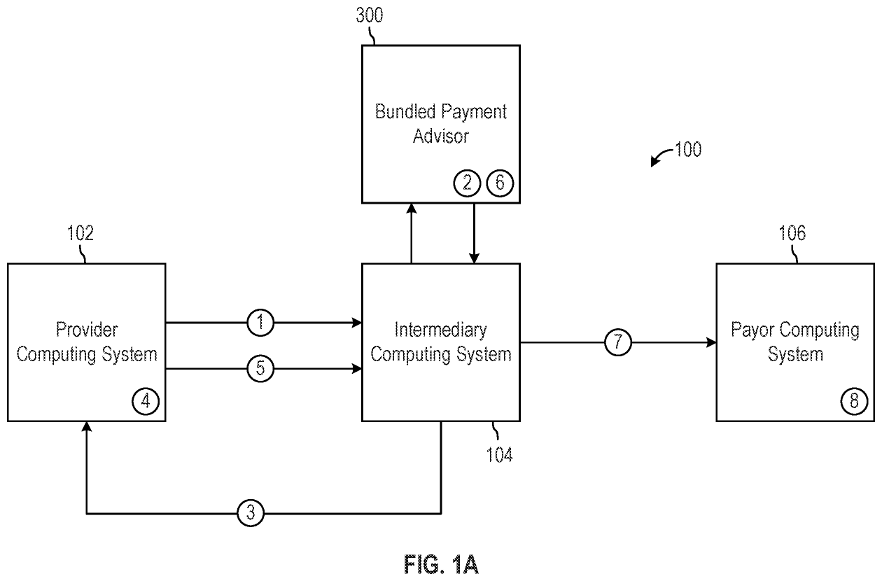

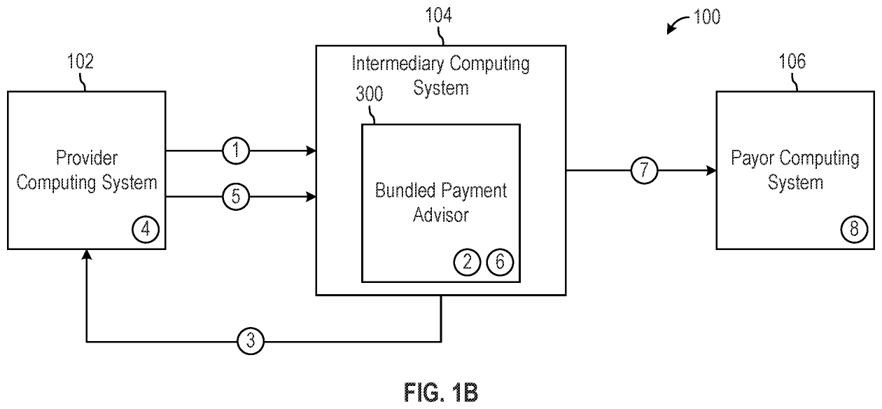

Turning first to FIG. 1A, a block diagram of an example communication architecture 100 for identifying and processing electronic health care claims that are part of bundled payment agreements is shown, according to some implementations. Architecture 100 is generally shown to include a provider computing system 102, an intermediary computing system 104, and a payor computing system 106. As described herein, provider computing system 102 is generally any computing system or device (e.g., a workstation, a server, etc.) that is operated by a party that submits electronic health care claims. For example, provider computing system 102 may be a computer operated by a health care provider. Similarly, payor computing system 106 is generally any computing system or device (e.g., a workstation, a server, etc.) that is operated by a party that submits payment for electronic health care claims. For example, provider computing system 102 may be a computer operated by a payor (e.g., a medical insurance company).

Intermediary computing system 104 may be any computing device (e.g., a server, etc.) that can intercept communications between provider computing system 102 and payor computing system 106, or that is configured to communicate with both provider computing system 102 and payor computing system 106. In some implementations, intermediary computing system 104 is a computer operated by a clearinghouse. It should be appreciated that, while only a single provider computing system 102 and payor computing system 106 are shown in the example of FIG. 1A, architecture 100 may include any number of provider and/or payor computing systems. For example, multiple different providers may submit health care claims to multiple different payors; thus, as generally described herein, intermediary computing system 104 may be generally configured to communicate with multiple different providers and payors. While not illustrated, it should also be appreciated that provider computing system 102, intermediary computing system 104, and/or payor computing system 106 may be communicably coupled via a direct connection or by any suitable network. For example, in some implementations, provider computing system 102, intermediary computing system 104, and payor computing system 106 are connected via the Internet using either wired or wireless connections.

As shown, architecture 100 further includes a Bundled Payment Advisor 300 which, as briefly described above, maintains a repository of bundled payment agreements and analyzes electronic health care claims to determine whether they are part of, or associated with, a bundled payment agreement. In some implementations, as in the example of FIG. 1A, Bundled Payment Advisor 300 may be a separate component from intermediary computing system 104 or, put another way, may be remote from intermediary computing system 104. For example, Bundled Payment Advisor 300 may be, or may be hosted on, another computing device, such as a web server. To this point, Bundled Payment Advisor 300 may be a web-based (e.g., online) tool that is remotely accessed by intermediary computing system 104, such as via application programming interface (API) call. In other implementations, as shown in FIG. 1B, Bundled Payment Advisor 300 may be a component of intermediary computing device 104.

With reference to both FIGS. 1A and 1B, processing of an electronic health care claim generally begins when the electronic health care claim is submitted (1) by a provider via provider computing system 102. Generally, a health care provider (e.g., a doctor, a hospital, etc.) can submit the electronic health care claim using their standard billing workflow. For example, the electronic health care claim can be created or populated and submitted in accordance with the health care provider's standard procedures. In some implementations, the electronic health care claim is submitted as an Electronic Data Interchange (EDI) 837 (“Health Care Claim”) transaction, although any other suitable format may be used. After submission, the electronic health care claim may be received, or intercepted, by Bundled Payment Advisor 300 (e.g., either directly or via intermediary computing system 104). Bundled Payment Advisor 300 may then evaluate (2) the electronic health care claim by extracting relevant attributes of the electronic health care claim and using the extracted attributes to determine whether the electronic health care claim is associated with a predefined (e.g., stored) bundled payment agreement. “Relevant attributes” are generally one or more attributes or data points of the electronic health care claim that can be used to determine whether the claim is associated with a bundled payment agreement. For example, the relevant attributes may include identifiers for the provider and payor, diagnosis or procedure codes, and the like.

If the electronic health care claim is determined to not be associated with a bundled payment agreement, then the electronic health care claim may be forwarded (7) to payor computing system without further input from Bundled Payment Advisor 300; though, Bundled Payment Advisor 300 may generally create a record of the evaluated claim for future auditing. If, however, the electronic health care claim is determined to be associated with a bundled payment agreement, then Bundled Payment Advisor 300 may further determine, based on the attributes of the electronic health care claim, whether certain criteria are met for submitting the electronic health care claim as part of a bundled payment. In some implementations, the criteria is that a billed amount for the electronic health care claim is set to zero (e.g., in some cases, any electronic health care claim submitted for a bundled payment agreement must have a zero-dollar billed amount).

However, other attributes of the electronic health care claim may also be used to determine whether the claim is suitable for bundling. For example, the electronic health care claim may simply include an indicator that marks the electronic health care claim as being part of a bundled payment agreement. In some implementations, Bundled Payment Advisor 300 can interface with a third-party system or database that includes a list or indication of “members” that are approved for an episode (e.g., a procedure), which can be used to determine, or supplement a determination, that a claim is associated with a bundled payment. For example, Bundled Payment Advisor 300 may retrieve a list of members or patients associated with a healthcare provider or payor that have been pre-approved for a particular surgery, and can then cross-reference a member identifier (e.g., in the electronic health care claim) with the list of approved members. In some implementations, Bundled Payment Advisor 300 may interface with a separate pre-authorization system which is used to determine and/or supplement determinations that a claim is associated with a bundle.

If the bundling criteria for the electronic health care claim are met, then a record of the claim and the evaluation of the claim may be generated, and the electronic health care claim may be forward (7) to payor computing system 106. Specifically, Bundled Payment Advisor 300 may extract and store certain information relating to the electronic health care claim and/or data relating to the evaluation of the electronic health care claim before the electronic health care claim is forwarded. If the bundling criteria are not met, however, then the claim may be rejected. Generally, in rejecting the claim, Bundled Payment Advisor is configured to generate a notification indicating that the claim was rejected and to transmit (3) one or both of the notification and the rejected claim to provider computing system 102. In some implementations, the claim is rejected via an EDI 277 (“Claim Status Response”) transaction. In some implementations, the notification not only indicates that the claim was rejected but may also indicate a reasoning for the rejection (e.g., “this claim is part of a bundled payment agreement, but the billed amount is not zero”) and may prompt the provider to resubmit the claim after making corrections. Additionally, a record is generally created for the electronic health care claim and the evaluation of the electronic health care claim by Bundled Payment Advisor 300 if the claim is rejected.

After receiving the notification that the health care claim was rejected, the provider that submitted the claim may have an opportunity to correct the claim (4) (e.g., as prompted by the notification) or to resubmit the claim as a fee-for-service claim. In some implementations, the provider may correct the claim by setting the billed amount to zero dollars. In other implementations, other attributes of the claim may be modified (e.g., adding an indication that the claim is part of a bundled payment agreement, etc.). After the claim is edited, the provider may submit the edited claim (5), which is received or intercepted by Bundled Payment Advisor 300 for analysis. In particular, Bundled Payment Advisor 300 may evaluate the edited claim (6) in the same way that a new claim is evaluated—by extracting attributes, using the attributes to determine whether the edited claim is part of a bundled payment agreement, and determining whether the edited claim meets the criteria for inclusion in the bundled payment agreement (e.g., determining if the billed amount is zero). Alternatively, the edited claim may be marked or otherwise indicated (e.g., by provider computing system 102) as being edited, such that Bundled Payment Advisor 300 does not need to reevaluate the claim to determine if it is part of a bundled payment arrangement. Rather, Bundled Payment Advisor 300 may simply determine whether any identified issues with the claim are corrected (e.g., that the billed amount is zero dollars).

In some implementations, the provider may have the option to resubmit a claim without editing, in which case the claim may be flagged or marked by Bundled Payment Advisor 300 and forwarded to payor computing system 106. For example, the resubmitted claim may include an identifier indicating that the claim was resubmitted without edits. In some implementations, Bundled Payment Advisor 300 may then simply record the transaction (e.g., information about the health care claim and the evaluation of the claim) and forward the resubmitted claim to payor computing system 106. In some such implementations, Bundled Payment Advisor 300 may flag the resubmitted claim for additional review by the payor based on the indication that the claim was resubmitted without edits. For example, Bundled Payment Advisor 300 may include an indicator with the claim, or may transmit a notification to payor computing system 300, indicating that the claim was rejected but resubmitted without edits. In some implementations, flagging the claim may further notify the provider and/or payor that the resubmitted claim still does not meet the predefined criteria. In any case, upon receiving a claim (e.g., either original or resubmitted), the payor may adjudicate the claim (8). In some implementations, as described below, adjudication may be implemented by/through Bundled Payment Advisor 300.

In some implementations, a payor can upload or enter claim details for out-of-network claims that represent leakage to the convener provider that the payor deems is associated with a bundled episode. This will allow the provider to understand the retrospective reconciliation process that the payor will execute, and account for a current or future reduced payment in their general ledger since the convener is unaware that the claim exists without the payor making such information available. Typically, these terms are included in any prospective bundled payment contract and usually specify a maximum amount that the convener will be held responsible for any leakage that occurs, making it clear that the provider is taking on the risk of entering into a bundled payment arrangement.

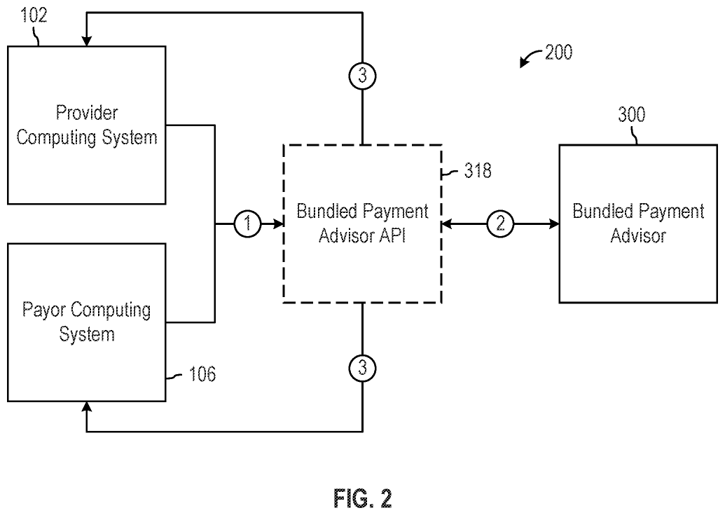

Referring now to FIG. 2, a block diagram of an example communication architecture 200 for checking whether an electronic health care claim is part of a bundled payment agreement before submission, according to some implementations. As noted above, another feature of Bundled Payment Advisor 300 (e.g., in addition to automatically detecting claims that are part of bundled payment agreements) is maintaining a repository of bundled payment agreements that can be accessed by multiple different parties. Architecture 200 illustrates an example of this feature, in which both provider computing system 102 and payor computing system 106 can access Bundled Payment Advisor 300 to view, add, remove, or otherwise edit bundled payment agreements. In this example, in particular, provider computing system 102 and/or payor computing system 106 may be accessing Bundled Payment Advisor 300 to check if a claim that is not yet submitted is part of a bundled payment agreement. It should be appreciated, however, that Bundled Payment Advisor 300 may be accessible by other parties and/or computing devices, so the following description of FIG. 2 may be generally applicable to any remote or third-party computing device that can access Bundled Payment Advisor 300.

As shown, architecture 200 generally includes a provider computing system 102, a payor computing system 106, and Bundled Payment Advisor 300, as described above. While not shown, it will be appreciated that, in some implementations, architecture 200 also includes intermediary computing system 104 (e.g., which hosts or communicates with Bundled Payment Advisor 300). Additionally, architecture 200 may optionally include a Bundled Payment Advisor API 318, which facilitates communication between Bundled Payment Advisor 300 and any external computing devices. In some such implementations, provider computing system 102 and a payor computing system 106 may communicate with Bundled Payment Advisor 300 via Bundled Payment Advisor API 318, such as through API calls.

To initiate an inquiry into whether a to-be-submitted claim is part of a bundled payment agreement, a payor or provider may submit (1) a full or partial health care claim to Bundled Payment Advisor 300 in order to determine whether the health care claim is part of a bundled payment agreement. In some implementations, the payor or provider may enter various attributes or parameters (e.g., claim elements) of a health care claim into a form to initiate an inquiry. For example, the payor or provider may access a web-based form via a Bundled Payment Advisor API 318 which has fillable fields that the payor or provider can populate with claim elements. In other implementations, the payor or provider may generate a health care claim in accordance with their standard procedures but, rather than submitting the claim for reimbursement, may submit the claim directly to Bundled Payment Advisor API 318 for review.

Upon receipt (e.g., via Bundled Payment Advisor API 318), Bundled Payment Advisor 300 may evaluate (2) the received claim elements against a repository of previously defined bundled payment agreements to determine whether the claim is part of a bundled payment agreement. In some implementations, in particular, Bundled Payment Advisor 300 looks for matches between claim elements and parameters of the bundled payment agreements. As described in greater detail below, these claim elements may include an identifier for the payor or provider that submitted the claim or claim elements, an identifier for the member or patient associated with the claim, diagnosis/procedure codes or any other identifier for the associated care event, and the like. To this point, evaluating a claim to determine whether it is part of a bundled payment agreement may be generally the same as evaluating a normally submitted claim using Bundled Payment Advisor 300 (e.g., as briefly described above), with the exception that the claim is not forwarded to a payor for reimbursement.

Based on the results of the evaluation, Bundled Payment Advisor 300 may return (3) either information related to the bundled payment agreement or an indication that the claim is not associated with a bundled payment agreement. In particular, if a match between the received claim elements and a bundled payment agreement is not found, Bundled Payment Advisor 300 may return a notification indicating that a match was not found. If a match between the received claim elements and a bundled payment agreement is found, however, Bundled Payment Advisor 300 may return a notification indicating that a match was found and providing details of the bundled payment agreement such as an identifier for the bundle, an identifier for the convener of the bundle, etc.

### Bundled Payment Advisor

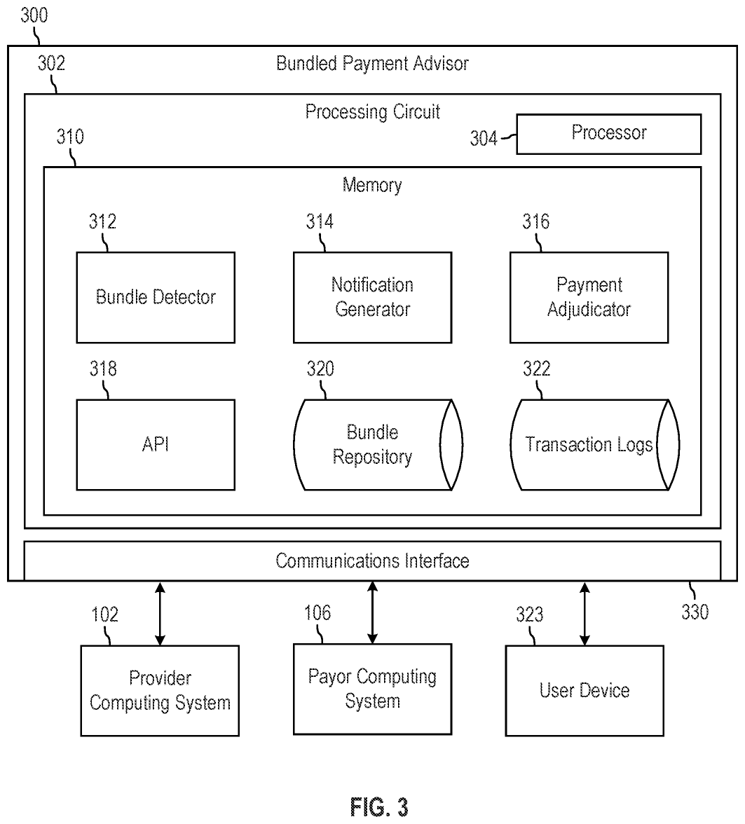

Referring now to FIG. 3, a detailed block diagram of Bundled Payment Advisor 300 is shown, according to some implementations. In some regards, Bundled Payment Advisor 300 may be better understood with reference to the preceding descriptions of FIGS. 1A, 1B, and 2, although these figures may not be explicitly referenced herein. As noted above, Bundled Payment Advisor 300 generally serves as a common repository for bundled payment agreements between multiple different providers and payors, which reduces the computational load on provider and payor computer systems in managing bundled payment agreements. Bundled Payment Advisor 300 is generally accessible by multiple external devices (e.g., both provider and payor computer systems) which provides all parties with clear insight into the parameters of bundled payment agreements, and which can allow both parties to edit agreement parameters.

Further, Bundled Payment Advisor 300 may greatly reduce computational loads on payor computing systems, which traditionally process each received health care claim individually with respect to bundled payments. To this point, Bundled Payment Advisor 300 can prospectively bundle claims such that payor computing systems may only need to spot check submitted claims for accuracy. By creating records of each claim and the evaluation of each claim, Bundled Payment Advisor 300 can also facilitate the reconciliation process for disputed claims or bundled payments, which is traditionally inefficient and overly complicated (e.g., as only one party may have visibility into the bundled payment agreement rules or due to insufficient tracking and management of submitted claims).

Bundled Payment Advisor 300 is generally shown to include a processing circuit 302 that includes a processor 304 and a memory 410. Processor 304 can be a general-purpose processor, an applicant specific integrated circuit (ASIC), one or more field programmable gate arrays (FPGAs), a group of processing components, or other suitable electronic processing structures. In some embodiments, processor 304 is configured to execute program code stored on memory 310 to cause Bundled Payment Advisor 300 to perform one or more operations, as described below in greater detail. It will be appreciated that, in embodiments where Bundled Payment Advisor 300 is part of another computing device (e.g., intermediary computing device 104), the components of Bundled Payment Advisor 300 may be shared with, or the same as, the host device. For example, if Bundled Payment Advisor 300 is implemented via intermediary computing device 104, then Bundled Payment Advisor 300 may utilize the processing circuit, processor(s), and/or memory of intermediary computing device 104 to perform the functions described herein.

Memory 310 can include one or more devices (e.g., memory units, memory devices, storage devices, etc.) for storing data and/or computer code for completing and/or facilitating the various processes described in the present disclosure. In some embodiments, memory 310 includes tangible (e.g., non-transitory), computer-readable media that stores code or instructions executable by processor 304. Tangible, computer-readable media refers to any physical media that is capable of providing data that causes Bundled Payment Advisor 300 to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory 310 can include RAM, ROM, hard drive storage, temporary storage, non-volatile memory, flash memory, optical memory, or any other suitable memory for storing software objects and/or computer instructions. Memory 310 can include database components, object code components, script components, or any other type of information structure for supporting the various activities and information structures described in the present disclosure. Memory 310 can be communicably connected to processor 304, such as via processing circuit 302, and can include computer code for executing (e.g., by processor 304) one or more processes described herein.

While shown as individual components, it will be appreciated that processor 304 and/or memory 310 can be implemented using a variety of different types and quantities of processors and memory. For example, processor 304 may represent a single processing device or multiple processing devices. Similarly, memory 310 may represent a single memory device or multiple memory devices. Additionally, in some embodiments, Bundled Payment Advisor 300 may be implemented within a single computing device (e.g., one server, one housing, etc.). In other embodiments, Bundled Payment Advisor 300 may be distributed across multiple servers or computers (e.g., that can exist in distributed locations). For example, Bundled Payment Advisor 300 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers.

Memory 310 is shown to include a bundle detector 312 which is configured to determine whether obtained health care claims are associated with a predefined bundled payment agreement. Generally, bundle detector 312 is configured to extract relevant attributes (also called “claim elements”) from an obtained electronic health care claim and to determine whether the health care claim is associated with a bundled payment agreement using the extracted attributes. In part, extracting the claim attributes includes automatically identifying information contained in the electronic health care claim that is relevant to determining whether the claim is part of a bundled payment agreement. For example, bundle detector 312 may extract data from certain fields or portions of an electronic health care claim. Alternatively, bundle detector 312 may use a machine learning model or other suitable algorithm to identify and extract data (e.g., strings of characters, words, phrases, numbers, etc.) from the health care claims.

The claim attributes extracted by bundle detector 312 generally include, but are not limited to, an identifier of the provider that submitted the claim (e.g., a national provider identifier (NPI)), an identifier of the payor that the claim is being submitted to (e.g., the payor's name or an identifier number), an identifier of the patient or member associated with the claim (e.g., the patient's insurance number), and an identifier of the care event associated with the claim (e.g., a procedure code, a diagnosis code, etc.). Other attributes may include an identifier for the place of service (e.g., an address, coordinates, etc.), a billed amount, etc.

In some implementations, bundle detector 312 determines whether an electronic health care claim is associated with a bundled payment agreement by comparing the extracted claim attributes against attributes of one or more bundled payment agreements stored in a bundle repository 320 (herein “bundle attributes”). For example, bundle detector 312 may look for matches between the extracted claims attributes and attributes of each bundle stored in bundle repository 320. If a match between one or more claim and bundle attributes is found, then the claim may be determined to be part of the corresponding bundled payment agreement. In some implementations, rules may be established as to the number of matching attributes that must be detected in order to consider the claim to be part of the bundled payment agreement. For example, a claim may not necessarily be part of a bundle if only one attribute (e.g., the provider identifier) matches. Instead, a predetermined set of attributes or a threshold number of attributes may need to match in order to consider the claim as being associated with the bundle. In some implementations, attributes may be compared in a predefined order to “filter” out unrelated bundled payment agreements. For example, bundled payment agreements may first be filtered by the provider identifier, then payor identifier, then diagnosis or procedure code.

Bundle repository 320, as described herein, is generally a database of predefined bundled payment agreements. Accordingly, bundle repository 320 generally includes various parameters associated with each bundled payment agreement (“bundle attributes”). In some implementations, bundle attributes are the same as, or similar to, the claims attributes mentioned above. For example, bundle repository 320 may include, for each bundled payment agreement, an indication of the provider(s) and payor(s) that established the agreement, an indication of the one or more procedure or diagnosis codes associated with the agreement, identifiers for the facilities or locations associated with the agreement, and any other information relating to the bundled payment agreement. More generally, each bundled payment agreement may be defined by the provider and payor that created the agreement, an indication of each care event (e.g., office visit, lab work, surgery, etc.) included under the agreement, and a payment amount.

In some implementations, each bundled payment agreement may further define a start event, which is a care event that initiates the corresponding bundled payment episode, and a trigger event, which closes the bundled payment episode and/or triggers adjudication of the bundled payment. In some implementations, bundled payment agreements are defined by users of Bundled Payment Advisory 300, such as providers and payors. In some implementations, bundle repository 320 maintains contracts that tie bundled episode definitions together for a service period (e.g., a calendar year). For example, terms, payment rates, workflow, or episode definitions may be modified overtime; accordingly, bundle repository 320 can maintain a history of the contracts in place and episode definitions and such that they are appropriately applied for each provider and payor by contract year. This can also aid in aa payor's retrospective reconciliations process in case some of the terms or episode definitions have changed.

In some implementations, bundled attributes include ranges of acceptable values. In some such implementations, bundle detector 312 may include and execute a probability model to generate a prediction of whether a claim is associated with a bundled payment agreement. For example, using the extracted claim attributes, bundle detector 312 may determine a likelihood that the claim is related to any care episode associated with the submitting provider or target payor. In some such implementations, identifiers for both the submitting provider and target payor (e.g., recipient) may be provided as inputs to the probability model. In some implementations, the probability model may be used to determine other providers (e.g., laboratories, diagnostic providers, etc.) that may be associated with the provider that submitted the claim. In some implementations, the probability model is a machine learning model.

Upon determining that an electronic health care claim is part of a bundled payment agreement, bundle detector 312 may further determine whether the claim meets one or more criteria for submission as part of a bundled payment. In some implementations, the criteria may be as simple as the inclusion of an identifier or marker indicating that the claim is part of a bundled payment agreement. In some implementations, claims that are to be included in a bundled payment may need to be submitted with a zero dollar billed amount (e.g., as opposed to a fee-for-service claim); thus, bundle detector 312 may determine whether the billed value of the electronic health care claim is zero dollars. Accordingly, if a claim is determined to be part of a bundled payment agreement and the billed value of the claim is zero dollars, bundle detector 312 may forward the claim to a payor. If, however, the claim is determined to be part of a bundled payment agreement, but the criteria are not met (e.g., the billed value is not zero dollars), then bundle detector 312 may cause a notification to be transmitted to the provider that submitted the claim. It should be appreciated that other bundling criteria are generally contemplated herein, and that bundle detector 312 is not limited to only the bundling criteria mentioned above. For example, in some implementations, the bundling criteria may be another dollar amount (e.g., any threshold value) or another criterion.

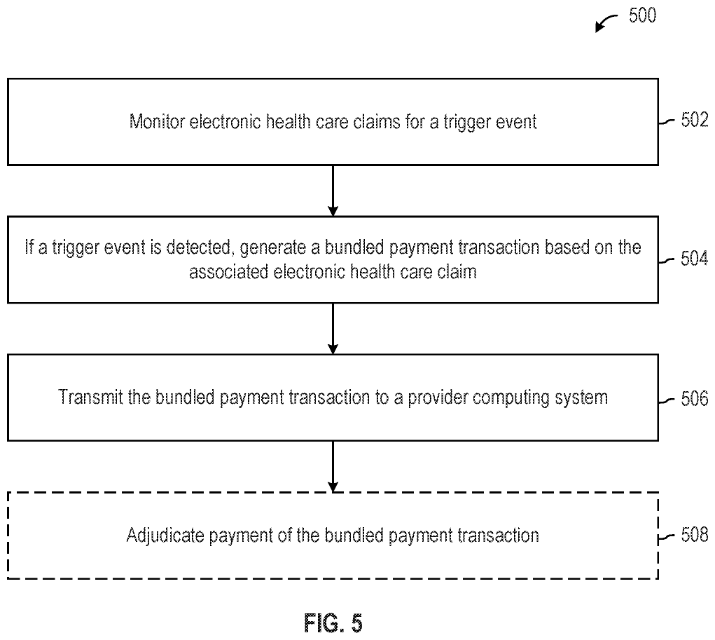

In some implementations, bundle detector 312 is further configured to determine whether a received electronic health care claim is a trigger event for a bundled payment agreement. A “trigger event” may be, a particular care event (e.g., an office visit, surgery, etc.) or other claim submission that “triggers” or initiates payment for the bundled payment episode. In some implementations, a trigger event is a particular diagnosis or procedure code. For example, a trigger event for a knee surgery bundled payment episode may be the submission of a claim for a post-care office visit or a procedure code for surgery. Generally, trigger events are defined for each bundled payment agreement and thus may be different for each bundled payment agreement. In some implementations, after determining that an electronic health care claim is part of a bundled payment agreement—and thus identifying the bundled payment agreement that the claim relates to—bundle detector 312 is configured to determine whether the electronic health care claim is or includes a trigger event. In some such implementations, bundle detector 312 determines whether the electronic health care claim is or includes a trigger event only after determining that the bundling criteria are not met. For example, bundle detector 312 may make a determination regarding the trigger event if the billed amount of a received claim is not zero, but the claim is otherwise associated with a bundled payment agreement. In other implementations, bundle detector 312 determines whether the electronic health care claim is or includes a trigger event before or concurrently with determining whether the bundling criteria are met. Additional description of detecting trigger events is provided below with respect to FIG. 5.

In addition, bundle detector 312 is generally configured to generate a record of each obtained and evaluated electronic health care claim. Specifically, bundle detector 312 may record (e.g., by generating a database entry) information such as the extracted claim attributes (e.g., the provider and/or payor identifiers, any diagnosis or procedure codes, etc.) and the results of the evaluation of the claim (e.g., an indication of whether the claim was determined to be part of a bundled payment). In some implementations, for example, bundle detector 312 may simply save a copy of each obtained claim and may append the copy of each claim with information relating to the bundled payment analysis described herein. In some implementations, the records created by bundle detector 312 are stored in a transaction log database 322.

Storing transaction logs may be useful in resolving disputes between providers and payors with respect to claim adjudication (e.g., reconciliation). Further, transaction logs may be stored for later auditing of claim payments and other related activities. In some implementations, transaction logs (e.g., stored in transaction log database 322) can also be used in determining whether an electronic health care claim is part of a bundled payment agreement. Specifically, historical data (e.g., transaction logs) for a particular provider or patient (e.g., based on provider or patient identifiers) can be used to predict whether a received electronic health care claim is associated with a bundled payment agreement. In some implementations, historical data is used to identify patterns in obtained health care claims (e.g., based on previously received claims). For example, bundle detector 312 may use transaction logs to estimate or predict how far along a patient is in a care episode (e.g., how close to completion the care episode is).

In some such implementations, bundle detector 312 can use transaction logs to predict when a next claim may be received for a particular bundled payment agreement. For example, bundle detector 312 may consider the time between past claim submissions for a particular care episode and/or the average time between claim submissions for care episodes of the same type to predict when a next claim may be received. In some implementations, Bundled Payment Advisor 300 can accordingly be configured to generate and/or transmit alerts notifying one or both of a provider and a payor if a claim submission is missing or received out of order. For example, Bundled Payment Advisor 300 may determine that more than the average amount of time has passed between claim submissions for a particular episode, and thus may send a provider a notification prompting them to submit the missing claim. In this way, Bundled Payment Advisor 300 can use historical claim data (e.g., transaction logs) to improve claim submission efficiency and accuracy.

As noted above, notifications may be sent to payors when it is determined that a health care claim is associated with a bundled payment agreement but doesn't meet one or more submission criteria (e.g., the billed amount is not zero). In such situations, a notification generator 314 of memory 310 may generate and transmit said notifications. Additionally, notification generator 314 can generate other notifications, such as to inform providers when claims have been forwarded to a payor. In some implementations, when a claim is rejected by bundle detector 312, notification generator 314 generates a notification identifying the rejected claim and, optionally, indicating a reason for the rejection, which is transmitted to the provider that submitted the rejected claim. In some such implementations, the notification may further prompt the provider to correct and resubmit the claim. For example, the notification may prompt the provider to adjust the billed amount of the claim to zero dollars for resubmission. In some implementations, notification generator 314 may further transmit a copy of the rejected claim back to the provider.

In some cases, the provider may correct the claim, as prompted by the notification, and resubmit the claim for verification by bundle detector 312. In some implementations, bundle detector 312 may evaluate resubmitted claims in the same manner as new claims (e.g., determining if the claim is part of a bundled payment agreement, determining whether one or more criteria are met for bundling, etc.). In other implementations, resubmitted claims may be identified or marked such that bundle detector 312 can simply check if the reasons for rejecting the claim are resolved. For example, bundle detector 312 may determine whether the billed amount of the resubmitted claim has been changed to zero dollars. In some implementations, bundle detector 312 determines whether a claim is resubmitted by comparing claim attributes against transaction logs database 322. In some implementations, resubmitted claims are tagged by the provider computing system before sending.

However, a provider may choose not to correct a rejected claim as prompted by notification generator 314 and may instead resubmit a claim without changes. In some such implementations, bundle detector 312 may first determine whether the claim has been edited. If it is determined that the claim was not corrected, then bundle detector 312 may flag or mark the resubmitted claim to indicate that the claim was resubmitted without corrections. In some implementations, bundle detector 312 may cause notification generator 314 to generate a second notification which is sent to one or both of the provider and payor computing systems 102, 106 prompting one or both of the provider and the payor to review the flagged claim. In some implementations, the flagged claim may then be forwarded to the payor for reconciliation. Likewise, upon determining that a resubmitted claim has been corrected and/or responsive to determining that an originally submitted claim meets the aforementioned bundling criteria, bundle detector 312 may forward the claim to the payor for further processing.

Optionally, memory 310 may further include a payment adjudicator 316 which adjudicates bundled payments. Put another way, payment adjudicator 316 may be configured to initiate a reimbursement process for a bundled payment episode and may coordinate the collection and transfer of funds between providers and payors. In some implementations, payment adjudicator 316 adjudicates payment for an episode once a trigger event is detected for the episode, as mentioned above. Generally, payment adjudicator 316 finalizes a bundled payment episode (e.g., by generating a report of all submitted claims for the episode) and transfers funds for the bundled payment episode to provider computing system 102 (generally, multiple providers). Further, payment adjudicator 316 may cause notification generator 314 to notify one or both of the provider and payor that the bundled payment episode is complete and that funds are being transferred. In some implementations, payment adjudicator 316 is configured to request or retrieve funds from payor computing system 102 to facilitate payment for a bundled payment episode. In some implementations, payment adjudicator 316 generates and/or maintains a general ledger (e.g., within transaction logs 322) of services that have been rendered, which providers that have rendered said services, what the agreed upon rate of payment would be for that the main (e.g., “anchor”) provider, and what the main provider would be paid for such a service. As noted above, in some implementations, payment adjudicator 316 can initiate payment for a bundled episode. Additionally, or alternatively, payment adjudicator 316 can generate a general ledger feed to an accounts payable systems.

Still referring to FIG. 3, Bundled Payment Advisor 300 is also shown to include a communications interface 330 that facilitates communications between Bundled Payment Advisor 300 and any external components or devices, including provider computing system 102 and payor computing system 106. Accordingly, communications interface 330 can be or can include a wired or wireless communications interface (e.g., jacks, antennas, transmitters, receivers, transceivers, wire terminals, etc.) for conducting data communications, or a combination of wired and wireless communication interfaces. In some embodiments, communications via communications interface 330 are direct (e.g., local wired or wireless communications) or via a network (e.g., a WAN, the Internet, a cellular network, etc.). For example, communications interface 330 may include one or more Ethernet ports for communicably coupling Bundled Payment Advisor 300 to a network (e.g., the Internet). In another example, communications interface 330 can include a WiFi transceiver for communicating via a wireless communications network. In yet another example, communications interface 330 may include cellular or mobile phone communications transceivers.

As mentioned above, in some implementations, communications to and/or from Bundled Payment Advisor 300 may be facilitated by Bundled Payment Advisor API 318. Specifically, Bundled Payment Advisor API 318 is an interface that allows remote and/or third-party computing systems to send data to or request data from Bundled Payment Advisor 300. Bundled Payment Advisor API 318 is generally any suitable API, such as a RESTful API. Accordingly, in some implementations, Bundled Payment Advisor 300 may be cloud-based (e.g., hosted on a cloud server) and Bundled Payment Advisor API 318 may facilitate communications with provider computing system 102 and payor computing system 106. Additionally, in some implementations, Bundled Payment Advisor 300 may be accessible to a user device 323 (e.g., via Bundled Payment Advisor API 318) such that a user can view or change data or otherwise control Bundled Payment Advisor 300. In some implementations, user device 323 is any computing device that is not a provider or payor computing device. For example, user device 323 may be a computer operated by a user that manages Bundled Payment Advisor 300. In some implementations, user device 323 is a display and/or user input device, such as a touchscreen, a display screen, a keyboard or keypad, etc.

As described above, a notable feature of Bundled Payment Advisor 300 is the ability for both providers and payors to access and edit bundled payment agreements. In some implementations, Bundled Payment Advisor API 318 provides this ability by facilitating communications with external computing devices. In some implementations, for example, providers and payors may access Bundled Payment Advisor 300 via a software application or web portal in order to view, edit, add, or remove bundled payment agreements. In some implementations, providers and payors can also access transaction logs in transaction log database 322 to review payments, submitted claims, and bundled transactions. In some implementations, Bundled Payment Advisor 300 provides an interface for reconciliation and disputes of submitted claims and bundled payments. For example, providers and payors may access Bundled Payment Advisor 300 via an online portal to initiate disputes. In some such implementations, Bundled Payment Advisor 300 can facilitate communications between providers and payors while maintaining records for later auditing.

### Bundled Payment Detection

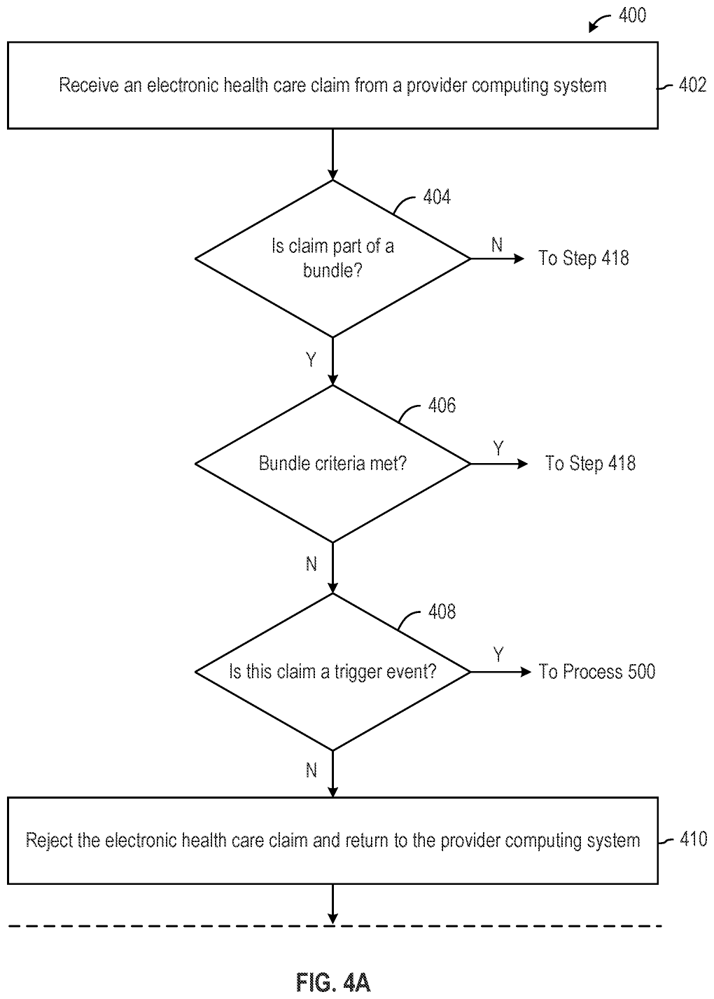

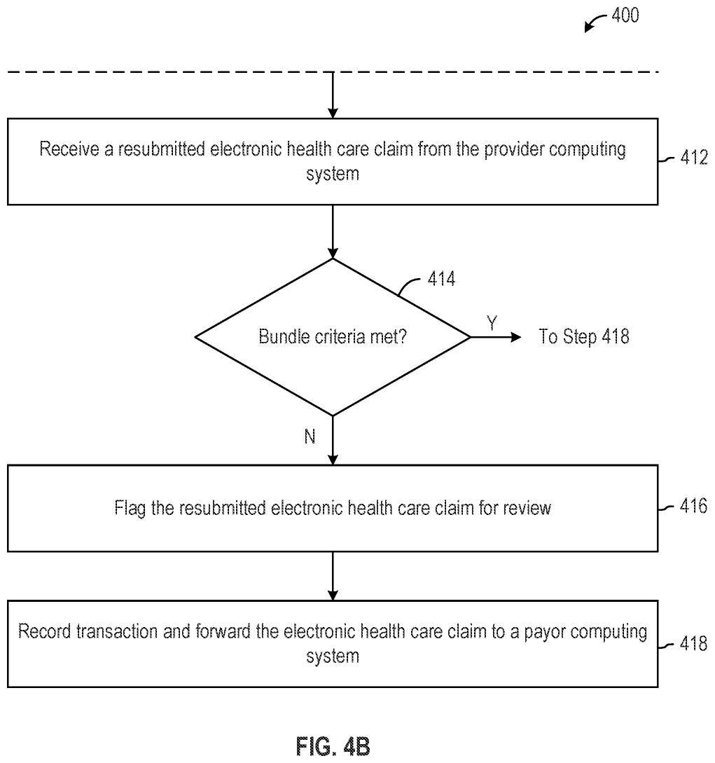

Referring now to FIGS. 4A and 4B, a flow diagram of a process 400 for automatically identifying electronic health care claims that are part of bundled payment agreements is shown, according to some implementations. In particular, process 400 is a way of prospectively bundling claims for payment that reduces the computational burden on both providers and payors. For example, with process 400, providers and payors do not need complicated, custom solutions for bundling payments and do not need to store large amounts of data to define bundled payments and record submitted claims. Instead, using process 400, Bundled Payment Advisor 300 can handle claim and bundled payment processing for any number of providers and payors. Further, process 400 can simplify reconciliation of claims by maintain records of submitted claims and processed bundled payments in a central location that is accessible by both providers and payors. To this point, it should be appreciated that process 400 may be performed by Bundled Payment Advisor 300, in some implementations. It will also be appreciated that certain steps of process 400 may be optional and, in some implementations, process 400 may be implemented using less than all of the steps. It will also be appreciated that the order of steps shown in FIG. 4 is not intended to be limiting.

At step 402, an electronic health care claim is received from a provider computing system. As noted above, the provider computing system is generally any computing device that is capable of generating and transmitting electronic health care claims. For example, the provider computing system may be a computer or server operated by a hospital or other medical provider. In some implementations, the electronic health care claim is received directly from the provider computing system; rather, the provider computing system may send the electronic health care claim to Bundled Payment Advisor 300 rather than to a payor. In other implementations, Bundled Payment Advisor 300 intercepts the electronic health care claim as it is being transmitted to the payor computing system. For example, Bundled Payment Advisor 300 may be, may be implemented by, or may be in communication with a clearinghouse which intercepts the electronic health care claim.

At step 404, a determination is made as to whether the electronic health care claim is associated with a bundled payment agreement. In some implementations, Bundled Payment Advisor 300 makes this determination by first extracting relevant attributes from the electronic health care claim. As described above, these relevant attributes, or “claim attributes”, may include any data in the claim that indicates whether the claim is part of a bundled payment agreement. Generally, the claim attributes that are extracted include a provider identifier (e.g., an NPI), a payor identifier, a patient identifier, and a diagnosis/procedure code or other similar identifier; although, it should be appreciated that any other data within a health care claim may be extracted. For example, in some cases, information such as a location of a care event associated with the claim, a date and/or time that the claim was submitted, etc., may be extracted.

After extracting the claim attributes, Bundled Payment Advisor 300 may use the extracted claim attributes to determine whether the electronic health care claim is associated with a bundled payment agreement. In some implementations, Bundled Payment Advisor 300 compares the claim attributes to attributes of a plurality of bundled payment agreements (“bundle attributes”). In some such implementations, Bundled Payment Advisor 300 uses a rules-based algorithm or technique for matching claims to bundled payment agreements. For example, Bundled Payment Advisor 300 may crawl through or query a bundled payment agreement repository (e.g., bundle repository 320) to identify matches between one or more claim attributes and one or more bundle attributes. In some implementations, a certain number or subset of claim and bundle attributes must match before the claim can be determined to be part of the associated bundled payment agreement. For example, each of the provider identifier, payor identifier, patient identifier, and episode identifier extracted from the claim may need to match to the attributes of a bundled payment agreement in order to identify the claim as being associated with the bundled payment agreement.

In some implementations, Bundled Payment Advisor 300 uses a probability model to generate a probability that an electronic health care claim is associated with a bundled payment agreement. In some such implementations, the one or more extracted claim attributes may be fed as inputs into the model, and a probability may be returned. In some implementations, a probability may first be calculated before Bundled Payment Advisor 300 attempts to match the claim to a bundled payment agreement, in order to save time and computational resources. For example, Bundled Payment Advisor 300 may only attempt to match claims with a probability of being associated with a bundled payment agreement that is above a predefined threshold (e.g., 50%). In any case, if it is determined that the electronic health care claim is not associated with a stored bundled payment agreement, then process 400 may continue to step 418, described below.

However, if it is determined that the electronic health care claim is associated with (e.g., matches) a stored bundled payment agreement, then, at step 406, Bundled Payment Advisor 300 may determine whether one or more bundling criteria are met based on the extracted claim attributes. In some implementations, the bundling criteria relate to the billed amount of the electronic health care claim. Specifically, the bundling criteria may dictate that the billed amount of the electronic health care claim is a predefined amount. In some such implementations, the bundling criteria may dictate that the billed amount of the electronic health care claim is zero dollars. As discussed above, a zero dollar billed amount may be an identifier for a claim that is being submitted as part of a bundled payment agreement or, more generally, may be one of one or more criteria that a claim must meet in order to be processed as part of a bundled payment. Claims that are part of bundled payment agreements may generally be submitted with a zero dollar billed amount, as each bundled payment agreement has a predefined cost. It will be appreciated, however, that other criteria may be evaluated at step 406 in order to determine if the claim is in an appropriate form for bundling. For example, rather than (or in addition to) setting the billed amount of the claim to zero, the claim may include an identifier or marker that indicates that the claim is to be bundled. If it is determined that the bundling criteria are met (e.g., that the billed amount is zero dollars), then process 400 may continue to step 418, described below.

If, however, the bundling criteria are not met (e.g., the billed amount is not zero dollars), then, at step 408, Bundled Payment Advisor 300 can optionally determine whether the electronic health care claim is or includes a trigger event. Alternatively, step 408 may be performed prior to or in conjunction with step 406. As discussed above, a trigger event is any activity that initiates payment for the bundled episode. For example, a particular procedure code may be a trigger event for a bundled payment agreement, although any other claim attribute can be used as a trigger. In some implementations, Bundled Payment Advisor 300 can use the extracted claim attributes (e.g., from step 404) to determine whether the electronic health care claim is or includes a trigger event. Thus, if a claim is determined to be associated with a bundled payment agreement and the claim is or includes a trigger event, process 400 may be interrupted or may continue to process 500, described below with respect to FIG. 5. At a high level, process 500 generally includes initiating and/or processing payment for the bundled episode. If the claim is not a trigger event, or does not include a trigger event, yet the claim is determined to be part of a bundle and does not meet the bundling criteria, then process 400 may continue to step 410.

At step 410, the electronic health care claim is rejected and optionally returned to the provider computing system. In some implementations, Bundled Payment Advisor 300 rejects a claim by generating and transmitting, to the provider computing system, a notification indicating that the claim was rejected and providing a reasoning for the rejection. For example, if the claim was rejected because the billed amount was not zero dollars, but it was determined that the claim was part of a bundled payment agreement, the notification may indicate that “this claim is part of a bundled payment agreement but was submitted as a fee-for-service claim.” In some implementations, the notification may further prompt the provider to correct the claim. For example, the notification may ask the user whether they want to resubmit the claim with the billed amount set to zero. Optionally, the provider may choose to resubmit the claim without any changes or may modify the claim in another way to overcome the rejection (e.g., by changing a claim attribute other than the billed amount). In some implementations, the notification includes a copy of the rejected claim (e.g., as an EDI 277 transaction) and may indicate, within the rejected claim, claim attributes that contributed to the rejection.

At step 412, a resubmitted electronic health care claim is received from the provider computing system. In some cases, the resubmitted electronic health care claim is an edited or modified version of the rejected claim, where the provider has corrected one or more issues identified by Bundled Payment Advisor 300. Upon receipt of a resubmitted claim, Bundled Payment Advisor 300 may evaluate the resubmitted claim as in steps 402-408. In other implementations, Bundled Payment Advisor 300 can first determine whether the claim was resubmitted and, if it is determined that the claim is a resubmitted claim, may simply determine whether any issues that led to the rejection of the claim are resolved. In other words, Bundled Payment Advisor 300 may repeat step 406 of process 400 without redetermining whether the claim is part of a bundled payment agreement.

At step 414, for example, Bundled Payment Advisor 300 may evaluate the resubmitted claim to determine if the bundling criteria are met. For example, Bundled Payment Advisor 300 may determine whether the billed amount of the resubmitted claim has been modified to zero dollars. In some implementations, the resubmitted claim may be marked as a resubmission or Bundled Payment Advisor 300 may evaluate the extracted claim attributes of the resubmitted claim against previously evaluated claims (e.g., including the rejected claim from which the resubmitted claim depends). In this manner, Bundled Payment Advisor 300 can quickly determine whether a received claim has been previously evaluated in order to save time and resources that would be required to redetermine whether the claim is part of a bundled payment agreement. If it is determined that the resubmitted claim meets the bundling criteria (e.g., that the resubmitted claim addresses any reasons for rejection), then process 400 may continue to step 418 described below.

If the resubmitted claim still does not meet the bundling criteria, then, at step 416, the resubmitted electronic health care claim is flagged for additional review. For example, an identifier or marker may be added to the resubmitted electronic health care claim indicating that the claim is part of a bundled payment agreement but doesn't meet the bundling criteria. In some implementations, flagging the resubmitted claim includes adding a flag to a database entry for the claim (e.g., when it is recorded by Bundled Payment Advisor 300). In some implementations, Bundled Payment Advisor 300 generates and transmits, to one or both of the provider and payor, a notification that identifies the resubmitted claim as being part of a bundled payment agreement but not meet the bundling criteria. Generally, the notification prompts one or both of the provider and payor to review the resubmitted in claim in greater detail (e.g., via a manual review). In some such implementations, the notification may indicate any issues that remain in the resubmitted claim.

In some cases, a provider may choose not to modify the claim as prompted by the notification sent at step 410 and may simply resubmit the claim as-is (e.g., without modifications). For example, the provider may choose to submit a claim as a non-zero-dollar fee-for-service claim, even if that claim is determined to be associated with a bundled payment agreement. In such cases, the resubmitted claim may be recorded and forwarded to a payor computing system (e.g., at step 418, described below). Alternatively, in some such implementations, the notification to the provider may provide an option for the provider not to edit the claim, in which case the provider simply selects the option not to edit the claim such that the claim is forwarded to the payor without resubmission. In either case, the claim may be flagged and/or a notification may be generated, as discussed above.

At step 418, details of the electronic health care claim and the evaluation of the electronic health care claim are recorded, and the electronic health care claim is forwarded to a payor computing system. In some implementations, the generated record is a “transaction log” that includes various data relating to both the claim and the determinations made by Bundled Payment Advisor 300. For example, the transaction log generally includes one or more claim attributes of the electronic health care claim, an indication of whether the electronic health care claim was determined to be associated with a bundled payment agreement, details of the bundled payment agreement associated with the claim (e.g., an identifier of the agreement), and an indication of whether or not the electronic health care claim was rejected. In some cases, if a claim is resubmitted, the transaction log may indicate that the claim was resubmitted and may include further details of the evaluation of the resubmitted claim. Generally, transaction logs may be maintained by Bundled Payment Advisor 300 such that one or both of the provider and payor can access the transaction logs for reconciliation, auditing, or other tasks.

### Bundled Payment Adjudication

Referring now to FIG. 5, a flow diagram of a process 500 for monitoring for, and detecting, a trigger event that initiates adjudication of a bundled payment is shown, according to some implementations. Like process 400, described above, process 500 can greatly reduce the computational requirements of provider and payor computing systems by handling the detection and adjudication of bundled payments. In some implementations, process 500 is at least partially implemented by Bundled Payment Advisor 300, as described above. It will be appreciated that certain steps of process 500 may be optional and, in some implementations, process 500 may be implemented using less than all of the steps. It will also be appreciated that the order of steps shown in FIG. 5 is not intended to be limiting. Additionally, as mentioned above, one or more steps of process 500 may be implemented responsive to the detection of a trigger event at step 408 of process 400. For example, in some such implementations, process 500 may begin at step 504.

At step 502, electronic health care claims are monitored to detect a trigger event. As discussed above with respect to FIG. 3, for example, electronic health care claims are generally received or intercepted by Bundled Payment Advisor 300 and evaluated to determine whether the claims are part of bundled payment agreements and, if so, whether the claims meet certain bundling criteria. As part of this evaluation process, Bundled Payment Advisor 300 may determine whether a received electronic health care claim is or includes a trigger event for an associated bundled payment episode. For example, a particular care event, procedure code, diagnosis code, or the like could be a trigger event. Accordingly, after determining that a claim is part of a bundled payment agreement, Bundled Payment Advisor 300 may compare extracted claim attributes to the predefined trigger event for the bundled payment agreement to determine if the claim is or includes the trigger event. In some implementations, step 502 is the same as, or similar to, step 408 of process 400 described above.

At step 504, a bundled payment transaction is generated based on the electronic health care claim if the trigger event is detected. Generally, the bundled payment transaction is the initialization of the adjudication process for a bundled payment episode and includes submission of a payment request, invoice, or the like to the payor to initiate payment for the bundled payment episode. In some implementations, Bundled Payment Advisor 300 generates a log of all activity related to a bundled payment episode which is sent to the payor. For example, the log may include the previously stored records relating to any received claims and claim evaluations. In some implementations, the bundled payment transaction is or includes a notification that prompts the payor to adjudicate the bundled payment. In some implementations, the bundled payment transaction includes generating a new claim that combines data from all previously received claims for a bundled payment episode.

At step 506, the bundled payment transaction is submitted to (e.g., transmitted to) a payor computing system. In some implementations, receiving the bundled payment transaction causes the payor computing system to adjudicate the bundled payment. For example, the bundled payment transaction may be a final bill or notification that prompts the payor to initiate the transfer of funds to the provider. In some implementations, the payor may be sent claims after evaluation by Bundled Payment Advisor 300 such that the payor computing system includes a local record of all claims for a bundled payment episode. In such implementations, Bundled Payment Advisor 300 may simply transmit, to the payor computing device, a notification indicating that the trigger event was detected, which prompts the payor to initiate payment for the bundled payment episode.

Optionally, process 500 may include step 508, in which Bundled Payment Advisor 300 itself facilitates adjudication of the bundled payment episode. For example, in some implementations, a notification is sent at step 506 that simply notifies the payor that the bundled payment episode is complete. In some such implementations, Bundled Payment Advisor 300 may then transmit a bundled payment transaction to the payor that prompts the payor to make a payment for the bundled payment episode. In conjunction, Bundled Payment Advisor 300 may transmit payment for the bundled payment episode to the provider computing device or a provider's bank account. In some cases, Bundled Payment Advisor 300 may make payments to multiple providers (each associated with the bundled payment episode) and may request a single payment from the provider. In this manner, Bundled Payment Advisor 300 simplifies payments for the payor and ensures that each provider is paid promptly.

### Bundled Payment Registry

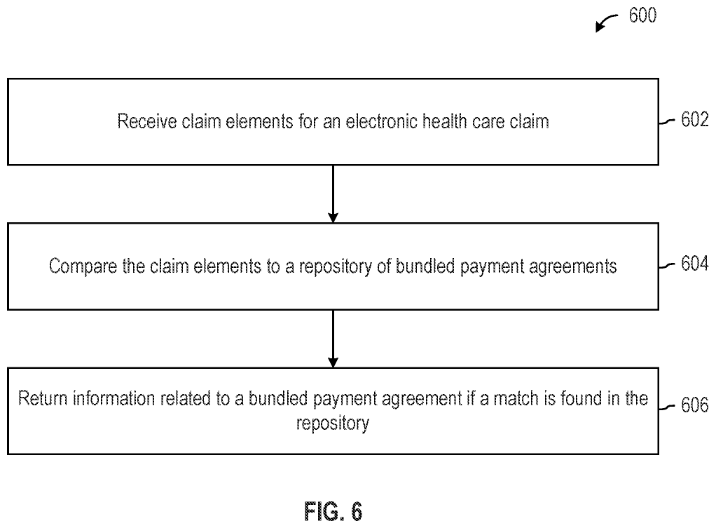

Referring now to FIGS. 6, a flow diagram of a process 600 for determining whether an electronic health care claim is part of a bundled payment agreement prior to submission is shown, according to some implementations. In some respects, process 600 is a way for providers, payors, or other users of Bundled Payment Advisor 300 to check whether a claim is part of a bundled payment agreement even before the claim is submitted. For example, a laboratory may use process 400 to check whether a test they are performing is part of a bundled payment agreement. To this point, in some implementations, process 600 is at least partially implemented by Bundled Payment Advisor 300, as described above. It will be appreciated that certain steps of process 600 may be optional and, in some implementations, process 600 may be implemented using less than all of the steps. It will also be appreciated that the order of steps shown in FIG. 6 is not intended to be limiting.

At step 602, claim elements relating to an electronic health care claim are received. In some implementations, the claim elements are received via a user input. For example, a user (e.g., a provider) may enter various claim elements into an online form hosted by Bundled Payment Advisor 300 or another software application. In some such implementations, the claim elements may be transmitted to Bundled Payment Advisor 300 via Bundled Payment Advisor API 318. For example, the form may be hosted on a website that interacts with Bundled Payment Advisor 300 via Bundled Payment Advisor API 318. In other implementations, a full or partial health care claim is received from a provider computing system; however, the full or partial health care claim is not submitted for processing. In some such implementations, the health care claim may be marked as incomplete or not for submission, or the health care claim may be submitted in a different manner than a completed health care claim. In some implementations, Bundled Payment Advisor 300 may extract the claim elements from the full or partial health care claim upon receipt.

At step 604, the claim elements are then compared to a repository of bundled payment agreements. Accordingly, it should be appreciated that step 604 may be substantially similar to step 404 of process 400 described above. For example, at step 604, the repository of bundled payment agreements may be queried or crawled to identify matches between received claim elements and bundle attributes associated with the stored bundled payment agreements. As discussed above, in some implementations, multiple claim elements—or at least a predefined set of claim elements—may need to match to the bundle attributes to consider the claim as part of the associated bundled payment agreement. In some implementations, a probability model is used to determine a probability that the claim elements are associated with a bundled payment agreement. For example, the claim elements may be fed as inputs into the probability model and a probability may be returned.

At step 606, if it is determined that the claim is associated with a bundled payment agreement, then information relating to the bundled payment agreement may be returned to the user's device and displayed. In some implementations, for example, the information may simply be an indication that the yet-to-be submitted claim is associated with a bundled payment agreement. In some implementations, the information may include details of the bundled payment agreement, such as identifying information, information about the payor and other providers, etc. If, however, the claim is determined not to match with a bundled payment agreement, then a notification may also be returned to the user indicating that the claim is likely not associated with a bundled payment agreement.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A system comprising:
a processor; and
a memory having instructions stored thereon that, when executed by the processor, cause the system to:
obtain, from a first computing device associated with a health care provider, an electronic health care claim;
compare attributes of the electronic health care claim to a repository of bundled payment agreements to determine whether: i) the electronic health care claim is associated with a bundled payment agreement between the health care provider and a payor, and ii) one or more bundling criteria are met;
reject the electronic health care claim if it is determined that the electronic health care claim is associated with a bundled payment agreement and that the one or more bundling criteria are not met, wherein rejecting the electronic health care claim includes transmitting a notification to the first computing device indicating a reasoning for rejecting the electronic health care claim and to prompting the health care provider to resubmit the electronic health care claim after modifying one or more portions of the electronic health care claim to meet the one or more bundling criteria; and
generate a transaction log comprising details of the electronic health care claim, an indication of whether the electronic health care claim is associated with a bundled payment agreement, and an indication of whether or not the electronic health care claim was rejected.

2. The system of claim 1, wherein the instructions further cause the system to transmit the electronic health care claim to a second computing device associated with the payor if it is determined that the electronic health care claim is associated with a bundled payment agreement and that the billed amount of the electronic health care claim is zero.

3. The system of claim 1, wherein the instructions further cause the system to:
determine whether the electronic health care claim is a fee-for-service claim before comparing attributes of the electronic health care claim to the repository of bundled payment agreements; and
transmit the electronic health care claim to a second computing device associated with the payor if it is determined that the electronic health care claim is a fee-for-service claim.

4. The system of claim 1, wherein the instructions further cause the system to:
obtain, from the first computing device and responsive to the electronic health care claim being rejected, a resubmission of the electronic health care claim;
determine whether a billed amount of the resubmitted electronic health care claim is zero; and
flag the resubmitted electronic health care claim for additional review if the billed amount is not zero.

5. The system of claim 1, wherein the instructions further cause the system to:
determine whether the electronic health care claim is or includes a trigger event after determining that: i) the electronic health care claim is associated with a bundled payment agreement between the health care provider and the payor, and ii) the one or more bundling criteria are met, and prior to rejecting the electronic health care claim, wherein the trigger event is a particular diagnosis or procedure code;
generate a bundled payment transaction for the bundled payment agreement responsive to determining that the electronic health care claim is or includes the trigger event; and
transmit the bundled payment transaction to a second computing device associated with the payor.

6. The system of claim 5, wherein the instructions further cause the system to adjudicate payment of the bundled payment transaction.

7. The system of claim 1, wherein the attributes of the electronic health care claim comprise one or more of a payor identifier, a provider identifier, a patient identifier, a diagnosis code, or a procedure code.

8. The system of claim 1, wherein obtaining the electronic health care claim comprises intercepting the electronic health care claim as it is communicated from the first computing device to the second computing device.

9. The system of claim 1, wherein the one or more bundling criteria include a billed amount of the electronic health care claim, and wherein the one or more bundling criteria are met if the billed amount of the electronic health care claim is zero dollars.

10. The system of claim 9, wherein prompting the health care provider to resubmit the electronic health care claim after modifying the one or more portions of the electronic health care claim to meet the one or more bundling criteria comprises prompting the health care provider to resubmit the electronic health care claim as either a fee-for-service claim or with a zero dollar billed amount.

11. A method comprising:
obtaining, by a first computing device, from a second computing device associated with a health care provider, an electronic health care claim;
comparing, by the first computing device, attributes of the electronic health care claim to a repository of bundled payment agreements to determine whether: i) the electronic health care claim is associated with a bundled payment agreement between the health care provider and a payor, and ii) one or more bundling criteria are met;
rejecting, by the first computing device, the electronic health care claim if it is determined that the electronic health care claim is associated with a bundled payment agreement and that the one or more bundling criteria are not met, wherein rejecting the electronic health care claim comprises transmitting a notification to the second computing device indicating a reasoning for rejecting the electronic health care claim and prompting the health care provider to resubmit the electronic health care claim after modifying one or more portions of the electronic health care claim to meet the one or more bundling criteria; and
generating, by the first computing device, a transaction log comprising details of the electronic health care claim, an indication of whether the electronic health care claim is associated with a bundled payment agreement, and an indication of whether or not the electronic health care claim was rejected.

12. The method of claim 11, further comprising transmitting, by the first computing device, the electronic health care claim to a third computing device associated with the payor if it is determined that the electronic health care claim is associated with a bundled payment agreement and that the billed amount of the electronic health care claim is zero.

13. The method of claim 1, further comprising:
determining, by the first computing device, whether the electronic health care claim is a fee-for-service claim before comparing attributes of the electronic health care claim to the repository of bundled payment agreements; and
transmitting, by the first computing device, the electronic health care claim to a third computing device associated with the payor if it is determined that the electronic health care claim is a fee-for-service claim.

14. The method of claim 11, further comprising:
obtaining, by the first computing device, from the second computing device and responsive to the electronic health care claim being rejected, a resubmission of the electronic health care claim;
determining, by the first computing device, whether a billed amount of the resubmitted electronic health care claim is zero; and
flagging, by the first computing device, the resubmitted electronic health care claim for additional review if the billed amount is not zero.

15. The method of claim 11, further comprising:
determining, by the first computing device, whether the electronic health care claim is or includes a trigger event after determining that: i) the electronic health care claim is associated with a bundled payment agreement between the health care provider and the payor, and ii) the one or more bundling criteria are met, and prior to rejecting the electronic health care claim, wherein the trigger event is a particular diagnosis or procedure code;
generating, by the first computing device, a bundled payment transaction for the bundled payment agreement responsive to determining that the electronic health care claim is or includes the trigger event; and
transmitting, by the first computing device, the bundled payment transaction to a third computing device associated with the payor.

16. The method of claim 15, further comprising adjudicating, by the first computing device, payment of the bundled payment transaction.

17. The method of claim 11, wherein the attributes of the electronic health care claim comprise one or more of a payor identifier, a provider identifier, a patient identifier, a diagnosis code, or a procedure code.

18. The method of claim 11, wherein obtaining the electronic health care claim comprises intercepting, by the first computing device, the electronic health care claim as it is communicated from the second computing device to a third computing device.

19. The method of claim 11, wherein the one or more bundling criteria include a billed amount of the electronic health care claim, and wherein the one or more bundling criteria are met if the billed amount of the electronic health care claim is zero dollars.

20. A non-transitory, computer readable medium having instructions stored thereon that, when executed by a processor, cause a device to:
obtain, from a first computing device associated with a health care provider, an electronic health care claim;
compare attributes of the electronic health care claim to a repository of bundled payment agreements to determine whether: i) the electronic health care claim is associated with a bundled payment agreement between the health care provider and a payor, and ii) one or more bundling criteria are met;
reject the electronic health care claim if it is determined that the electronic health care claim is associated with a bundled payment agreement and that the one or more bundling criteria are not met, wherein rejecting the electronic health care claim includes to transmit a notification to the first computing device indicating a reasoning for rejecting the electronic health care claim and prompt the health care provider to resubmit the electronic health care claim after modifying one or more portions of the electronic health care claim to meet the one or more bundling criteria; and
generate a transaction log comprising details of the electronic health care claim, an indication of whether the electronic health care claim is associated with a bundled payment agreement, and an indication of whether or not the electronic health care claim was rejected.
